(19) United States
(12) Patent Application Publication
(10) Pub. No.: US 2013/0173754 A1
(43) Pub. Date: Jul. 4, 2013

(54) METHOD AND APPARATUS TO EXCHANGE DIGITAL CONTENT BETWEEN TWO DEVICES WITHOUT REQUIRING THE EXCHANGE OF CREDENTIALS

(71) Applicant: Scannx, Inc., Pleasanton, CA (US)

(72) Inventors: Ron van Os, Boulder, CO (US); John Dexter, Mableton, GA (US)

(73) Assignee: SCANNX, INC., Pleasanton, CA (US)

(21) Appl. No.: 13/706,218

(22) Filed: Dec. 5, 2012

Related U.S. Application Data
(60) Provisional application No. 61/630,285, filed on Dec. 8, 2011.

(51) Int. Cl. H04L 29/08

(52) U.S. Cl. CPC H04L 67/02
USPC 709/219

(57) ABSTRACT

A method and apparatus for exchanging digital content between two devices are described. In one embodiment, the method comprises converting a paper document into digital content; transferring the digital content via a network to a remotely accessible data storage server; displaying a code on a display, where the code encoding an address of the digital content in the network; monitoring whether the digital content has been accessed; receiving a request for the digital content from a second device, the request including the address created from data resulting from decoding the code; and sending an HTML content stream to the second device, including an indication of a type of the digital content, in response to the request, the type information for use by a browser in determining an application or plug-in capable of rending the digital content on a display of the smart device.

### PRIORITY

The present patent application claims priority to and incorporates by reference the corresponding provisional patent application Ser. No. 61/630,285, titled, “A Simple Method to Exchange Digital Content Between a Walk-Up Kiosk and a Smart Device Without Requiring the Exchange of Credentials,” filed on Dec. 8, 2011.

### FIELD OF THE INVENTION

Embodiments of the present invention relate to the field of document capture and retrieval; more particularly, embodiments of the present invention relate to exchanging digital content that has been captured between two devices without requiring an exchange of credentials.

### BACKGROUND OF THE INVENTION

Document capture and retrieval are commonly used to create digital content that may be stored and subsequently accessed by users. The digital content can originate from a camera or document scanning station or document scanner attached to a computer, which convert documents and/or images to digital content. Once the content has been created, it may be transferred and stored in memory.

Many current state of the art document capture and retrieval systems require an end user to enroll or subscribe to a web-based service by use of some sort of credentials. These credentials are typically a username and password. To store or upload digital content, the end user needs to login to the service and transfer the content to the service. Thereafter, in order to retrieve or otherwise access the content, the end user needs to repeat the login process. Software in these systems or other devices allows the end user to login and access the digital content.

### SUMMARY OF THE INVENTION

A method and apparatus for exchanging digital content between two devices are described. In one embodiment, the method comprises converting a paper document into digital content; transferring the digital content via a network to a remotely accessible data storage server; displaying a code on a display, where the code encoding an address of the digital content in the network; monitoring whether the digital content has been accessed; receiving a request for the digital content from a second device, the request including the address created from data resulting from decoding the code; and sending an HTML content stream to the second device, including an indication of a type of the digital content, in response to the request, the type information for use by a browser in determining an application or plug-in capable of rending the digital content on a display of the smart device.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a data flow diagram illustrating paper documents being run through an acquisition device capable of converting the paper documents into digital content representing the same.

FIG. 2 illustrates one embodiment of a display device attached to a computing system having rendered a QR Code as shown in FIG. 1.

FIG. 3 illustrates an example of screen content rendered on one embodiment of a display device attached to a computing device from FIG. 2.

FIG. 4 illustrates an interaction between a computing device (e.g., a kiosk) and a data storage server, such as the data storage server shown in FIG. 1.

FIG. 5 is a block diagram of one embodiment of a computer system.

FIG. 6 illustrates a set of code (e.g., programs) and data that is stored in memory of one embodiment of a computer system.

FIG. 7 is one embodiment of a user interface for selecting scan settings.

FIG. 8 is one embodiment of a user interface for starting a scan operation, including selecting one or more scan options.

### DETAILED DESCRIPTION OF THE PRESENT INVENTION

A method and apparatus for facilitating a secure transfer of information from a device (e.g., an acquisition device, such as a large size scanner, camera, etc.) to another device, such as mobile smart device (e.g., an iPhone). In one embodiment this occurs without requiring knowledge of wireless connectivity opportunities like hotspots, nor with the exchange of user credentials or a physical connection between the devices. That is, embodiments of the present invention removes any requirement that involved supplying credentials, thereby greatly simplifying the process of digital content exchanges.

In addition, the method and apparatus provides inherent resiliency to ensure reliable data transfer (in those cases where the wireless connectivity is less reliable) by supporting time asynchronous transfers and providing persistent temporary storage of the data in transit.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

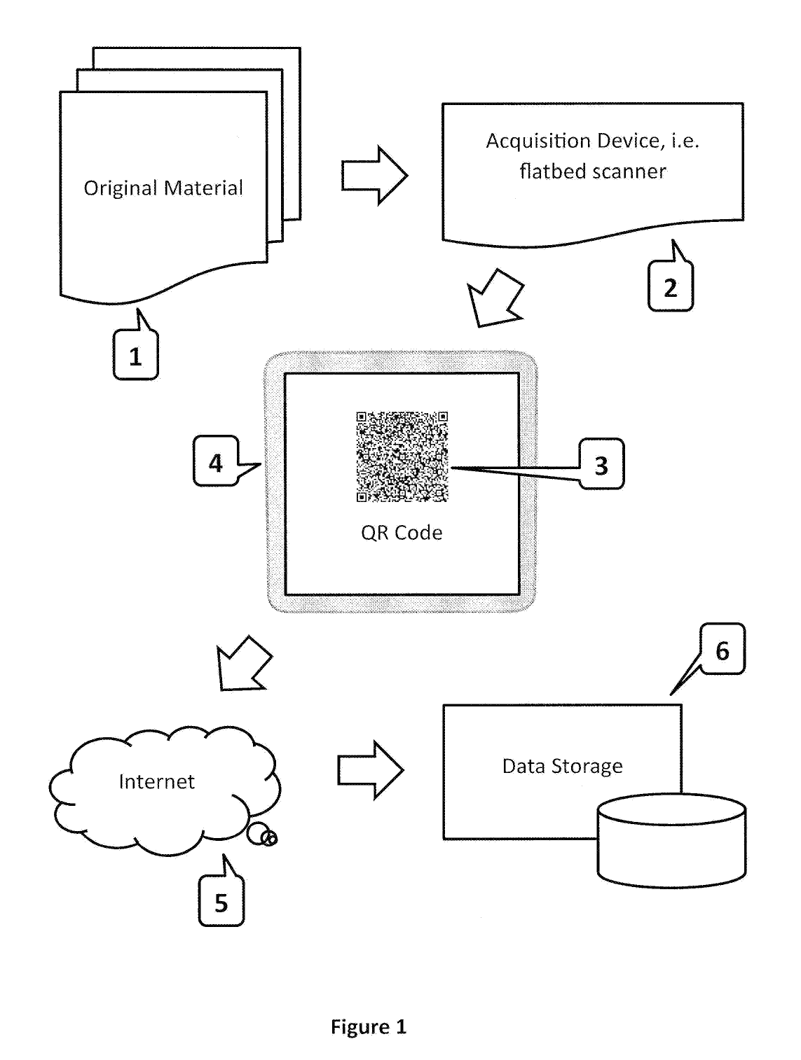

FIG. 1 is a data flow diagram illustrating the use of an acquisition device to convert paper documents into digital content representing the same. In one embodiment, the acquisition device is part of a computer system and/or kiosk.

Referring to FIG. 1, original material 1 (e.g., paper documents) are run through an acquisition device 2 capable of converting the paper documents into digital content representing the same. The digital content is transferred to a computing device 4 (e.g., a desktop computer system, a fully embedded computer system, etc.) and stored on its local storage media (e.g., a hard drive, a solid storage drive, etc.). Once the entire digital content has been received, computing device 4 transfers the digital content through a network 5 (e.g., the internet) to a remotely accessible data storage server 6.

During or after completion of the transfer of the digital content to data storage server 6, the display device attached to or part of computing system 4 renders a code 3 (e.g., a QR (Quick Response) code, 2-D bar code, glyph, etc.) on its screen. In one embodiment, code 3 is a type of matrix barcode capable of encoding any kind of data. In one embodiment, code 3 encodes a publicly accessible internet address of the digital content, for example: ‘https://www.exampleserver.com/xxxxxxx.pdf’. In another embodiment, code 3 encodes another type of locator used to locate content in a network. In one embodiment, the address generated and encoded in code 3 contains a machine generated random collection of characters, in order to make it difficult for other parties to access the same content.

In one embodiment, acquisition device 2 is attached to computing device 4. It is not implied that these are distinct and separate devices; they can be part of a single intelligent scanning device or multiple function peripheral (MFP) with a display device incorporated. Furthermore, in one embodiment, server 6 of FIG. 1 is a distinct single internet connected device or a virtual device hosted inside an internet connected cloud computing environment.

Note that while FIG. 1 depicts examples of discrete paper documents. Embodiments of the present invention are not limited to these kinds of originals; books magazines, newspapers and the like are all part of the definition of ‘original material’.

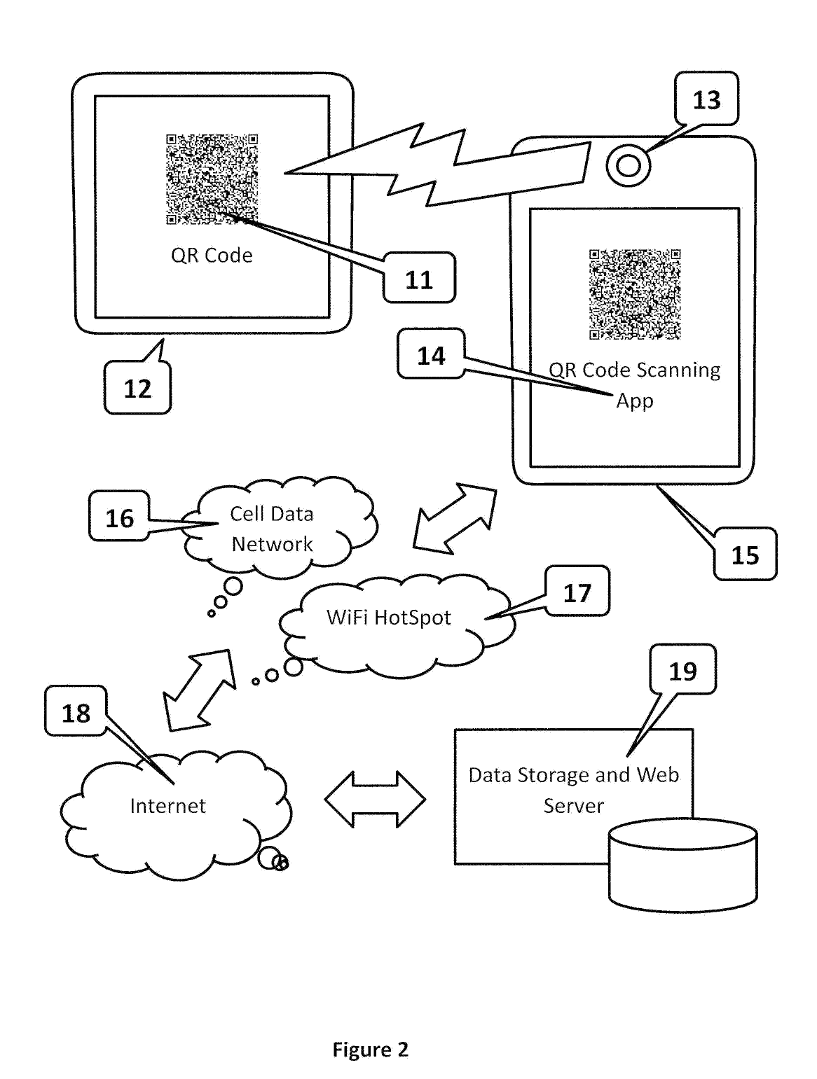

FIG. 2 illustrates one embodiment of a display device attached to a computing system having rendered a QR Code. Referring to FIG. 2, the display device attached to computing system 12 having rendered a QR Code 11 as described herein, instructs the user to launch an application 4 on mobile device 15 and acquire or capture the QR code 11 using camera 13 embedded within the smart device. Mobile device 15 may comprise a smart device, such as, for example, an iPhone, iPad, windows Phone, and many Android Phones/Pads.

Once application 4 has acquired a digital representation of the QR Code 11, it decodes the data and retrieves the publicly accessible internet address or URL (Universal Resource Locator) of the digital content representing the original material (e.g., original material 1 from FIG. 1). Application 4 validates the proper formatting of the URL and subsequently launches a browsing application on mobile device 15 to access the content pointed to by the URL. The connection is either made through a cell data network 16, or a direct wireless connection 17 if a WIFI hotspot is in range, through the internet 18, to the data storage server 19. In one embodiment, data storage server 19, through web server software running on it, returns a HTML content stream, including the MIME type of the content in the headers. Once mobile device 15 browsing application retrieves the MIME type from the headers, it can launch another application or plugin capable of rendering the digital content as well as storing the content on the mobile device 15.

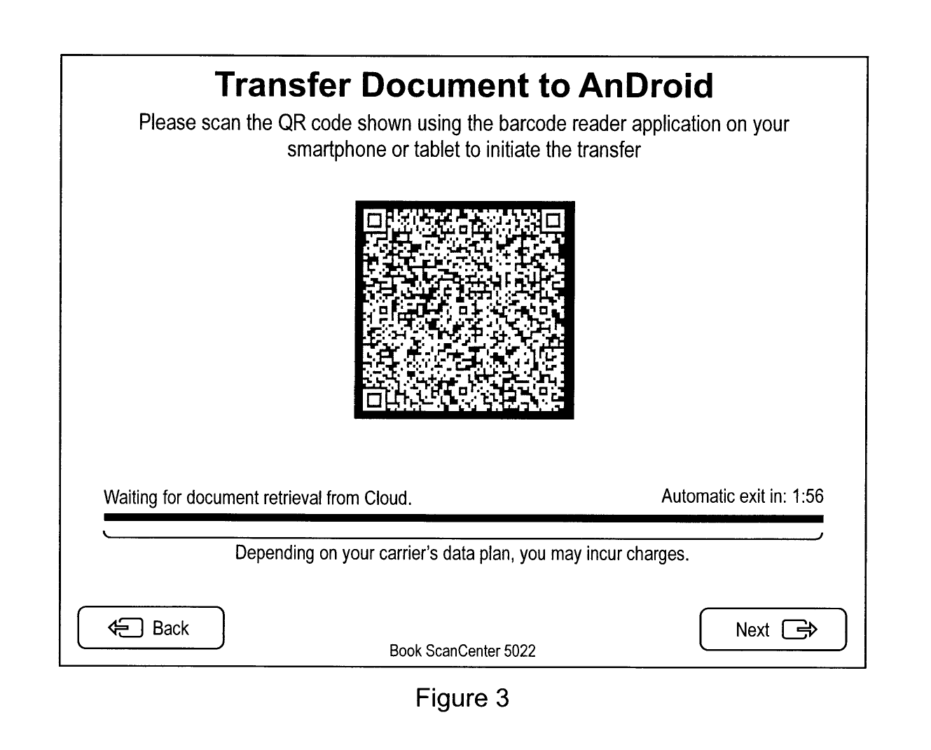

FIG. 3 shows an example of the screen content rendered on the display device attached to a computing device, such as, for example, computing device 2 of FIG. 2. While this screen is shown, software running on computing device 2 periodically checks with data storage server 9 of FIG. 2 to determine whether the content has been accessed. If it is determined that the content was accessed, the display device informs the users that the digital content was successfully transferred and completes the transaction. In one embodiment, upon successful transfer, data storage server 9 deletes the digital content and redirects the URL used to access the content to a HTML content informing the user that the content has been deleted. If the transfer was unsuccessful, data storage server 9 retains the digital content for a defined period (e.g., 3 days; a predetermined number of days; a predetermined number of hours, etc.) before deleting the content.

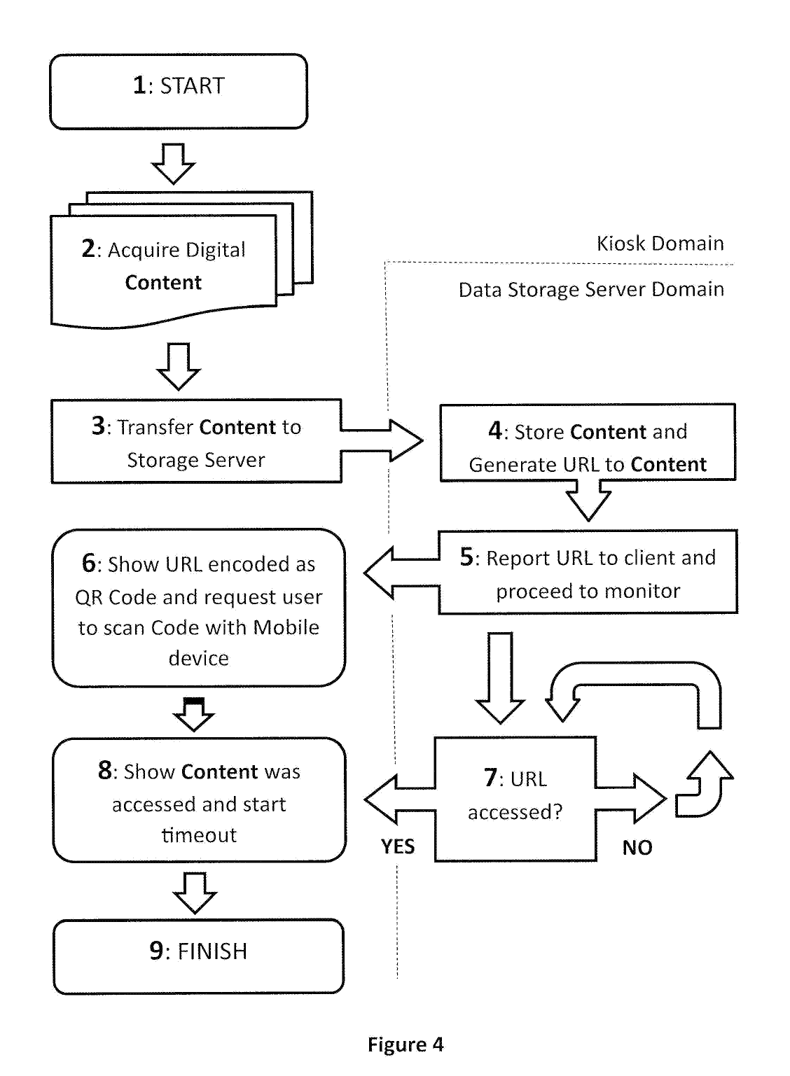

FIG. 4 is a data flow diagram depicting the operations performed by and the interaction between computing device 4 (e.g., kiosk), and data storage server 6 of FIG. 1 in more detail. The operations are performed by processing logic that may comprise hardware (circuitry, dedicated logic, etc.), software (such as is run on a general purpose computer system or a dedicated machine), or a combination of both.

Referring to FIG. 4, the interaction starts (1) once a user initiates the transfer software of their device (e.g., smart phone, PDA, etc.) by touching the appropriate button on the touchscreen on the computing device (e.g., kiosk) (or another button or input mechanism on the device). The user acquires (2) the desired original materials, i.e. magazine pages, book pages or other paper documents, after which the digital representation of the same is transferred (3) to a storage server. Once the storage server has received the entire digital content, the storage server returns (5) a publicly accessible URL of the content to the computing device and continues to monitor (7) whether or not the content was accessed. Meanwhile, the computing device renders a QR code of the URL and instructs the user to scan the code using the mobile devices QR code reader that operates under direction of a QR code reader application (6). While the computing devices waits for the user to obtain and decode the QR code, the computing device periodically checks with the storage server to determine if the content was accessed. Once the user has accessed the content, the computing device completes the transaction (9) and returns to its idle state ready for the next user. The dashed line in FIG. 4 represents the respective domains of the computing device (e.g., kiosk) application and the data storage server with all interactions happening across a network (e.g., the internet).

It should be apparent from the descriptive above that the data transfer is inherently resilient. If the entire content was not transferred, the original data remains on the server and can be retrieved at a later time. This is an important feature when the connectivity runs across a cell data network that can be unreliable. In addition, after retrieving the content URL, the user can choose not to download the entire content while at the computing device and wait till they are near a reliable network (e.g., a reliable WiFi network) to avoid data charges and overruns.

Thus, in one embodiment, the method performed by the computing system includes converting a paper document into digital content, transferring the digital content via a network to a remotely accessible data storage server, displaying a code on a display, the code encoding an address of the digital content in the network, monitoring whether the digital content has been accessed, receiving a request for the digital content from a second device, the request including the address created from data resulting from decoding the code, sending an HTML content stream to the second device, including an indication of a type of the digital content, in response to the request, the type information for use by a browser in determining an application or plug-in capable of rending the digital content on a display of the smart device, sending a message to the second device for display to a user indicating the digital content was transferred, and deleting the digital content from the remotely accessible data storage server.

Similarly, the method performed by the mobile device comprises: acquiring a code displayed on a display of a first device using a camera of a second device, where the code encodes an address of digital content stored in a remotely accessible data storage server coupled to a network after being converted from a paper document and transferred to the remotely accessible data storage server; decoding data in the code; creating the address from the data; sending a request for the digital content through the network using the address created from the data; receiving an HTML content stream from a remotely accessible data storage server, including an indication of the a type of the digital content, in response to the request; retrieving the type from headers in the HTML content stream; launching an application or plug-in capable of rendering the digital content; and rendering the digital content on a display of the second device; monitoring whether the digital content has been accessed; determining the digital content was accessed; and receiving and displaying a message indicating the digital content was transferred and is to be subsequently deleted from the remotely accessible data storage server.

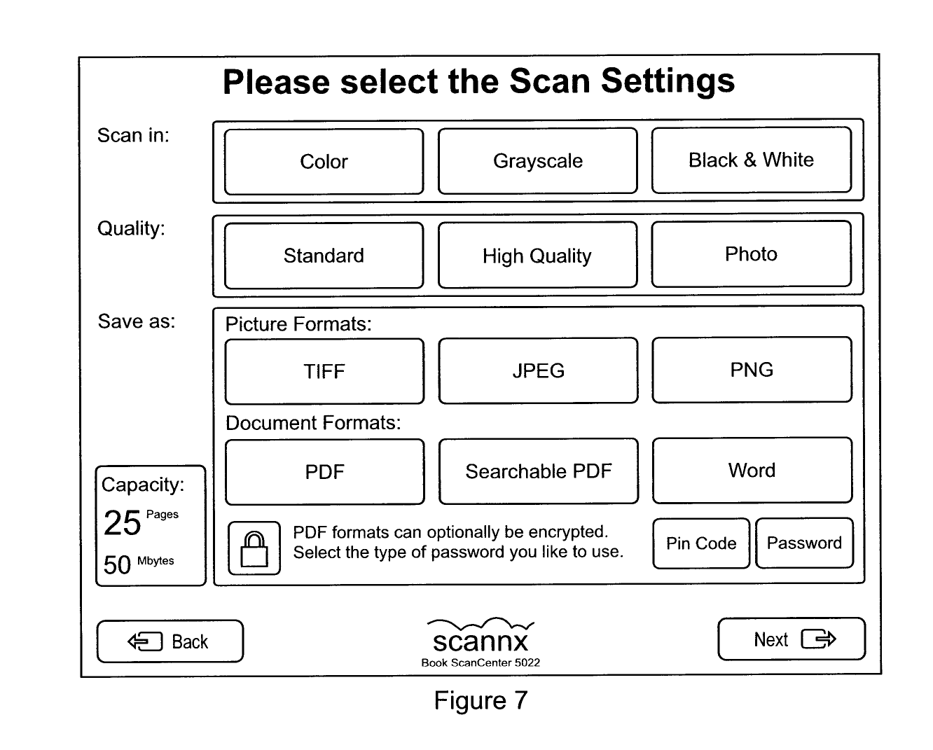

FIG. 7 is one embodiment of a user interface for selecting scan settings. Referring to FIG. 7, the user interface allows a user to select scan-in options (e.g., color, grayscale, black & white), quality options (e.g., standard, high quality) and save options (e.g., TIFF, JPEG, PNG), as well as document formats (e.g., PDF, searchable PDF, Word). In one embodiment, the user interface also allows a user to encrypt PDF formats, including selecting the PIN code or password).

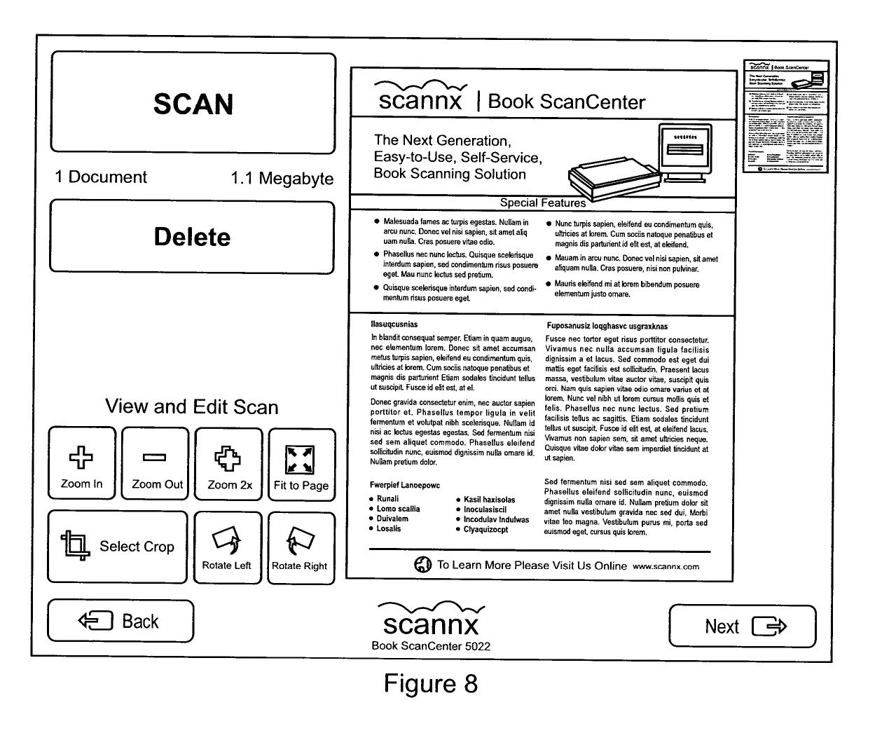

FIG. 8 is one embodiment of a user interface for starting a scan operation, including selecting one or more scan options. Referring to FIG. 8, the user interface allows a user to perform a scan by selecting a SCAN button on the interface. In one embodiment, the user interface also the user to perform view and edit scan options that include one or more of zoom in, zoom out, fit to page, select crop, rotate left, and rotate right.

In one embodiment, the scan operation is able to recognize that a document is not positioned correctly and automatically corrects the position of the scanned version of the document so that the user receives the content correctly positioned. For example, if the document is scanned up-side-down, the scan operation determines that the document is up-side-down and after scanning in the document, causes the document to be rotated and appear right-side-up.

### An Example of a Computer System

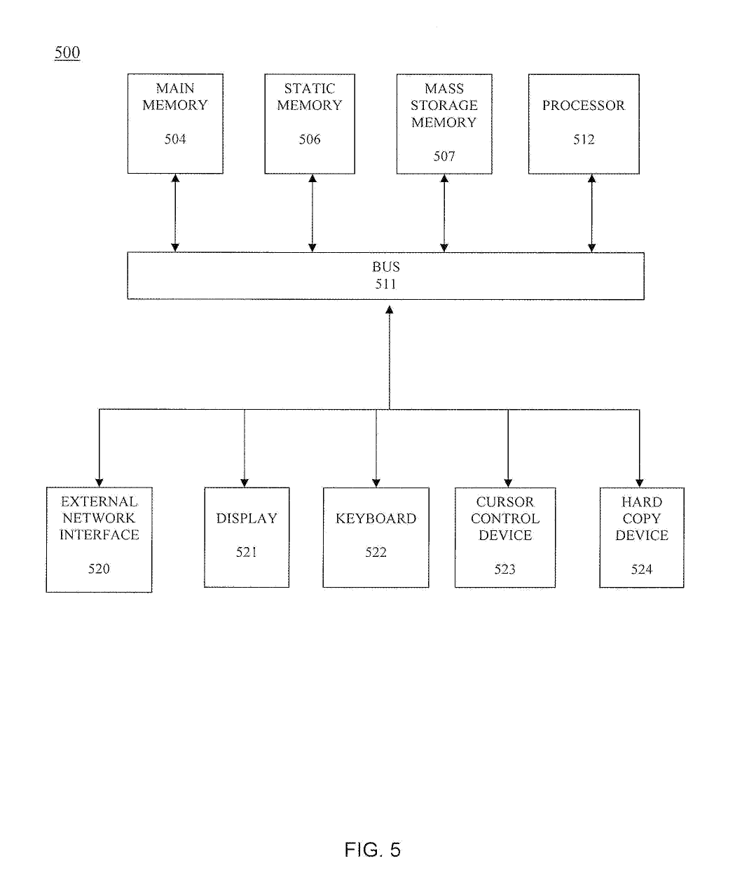

FIG. 5 is a block diagram of an exemplary computer system that may perform one or more of the operations described herein. Referring to FIG. 5, computer system 500 may comprise an exemplary client or server computer system. Computer system 500 comprises a communication mechanism or bus 511 for communicating information, and a processor 512 coupled with bus 511 for processing information. Processor 512 includes a microprocessor, but is not limited to a microprocessor, such as, for example, Pentium™, PowerPC™, Alpha™, etc.

System 500 further comprises a random access memory (RAM), or other dynamic storage device 504 (referred to as main memory) coupled to bus 511 for storing information and instructions to be executed by processor 512. Main memory 504 also may be used for storing temporary variables or other intermediate information during execution of instructions by processor 512.

Computer system 500 also comprises a read only memory (ROM) and/or other static storage device 506 coupled to bus 511 for storing static information and instructions for processor 512, and a data storage device 507, such as a magnetic disk or optical disk and its corresponding disk drive. Data storage device 507 is coupled to bus 511 for storing information and instructions.

Computer system 500 may further be coupled to a display device 521, such as a cathode ray tube (CRT) or liquid crystal display (LCD), coupled to bus 511 for displaying information to a computer user. An alphanumeric input device 522, including alphanumeric and other keys, may also be coupled to bus 511 for communicating information and command selections to processor 512. An additional user input device is cursor control 523, such as a mouse, trackball, trackpad, stylus, or cursor direction keys, coupled to bus 511 for communicating direction information and command selections to processor 512, and for controlling cursor movement on display 521.

Another device that may be coupled to bus 511 is hard copy device 524, which may be used for marking information on a medium such as paper, film, or similar types of media. Another device that may be coupled to bus 511 is a wired/wireless communication capability 525 to communication to a phone or handheld palm device.

Note that any or all of the components of system 500 and associated hardware may be used in the present invention. However, it can be appreciated that other configurations of the computer system may include some or all of the devices.

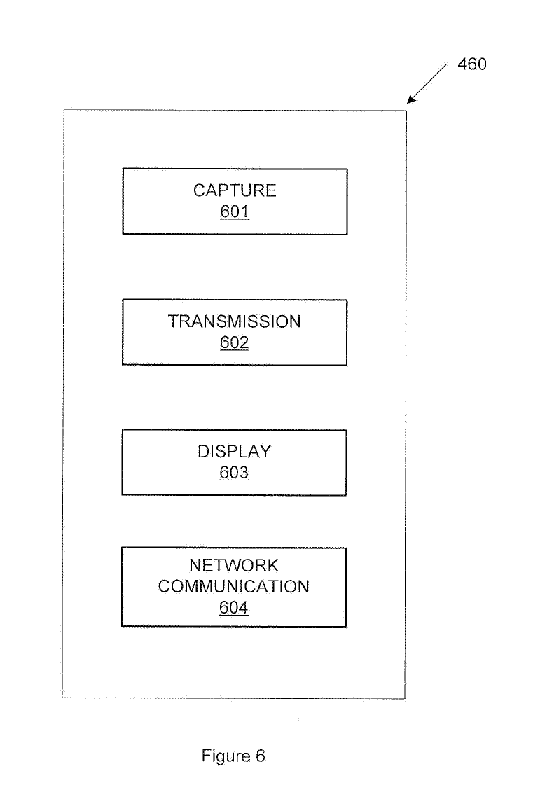

FIG. 6 illustrates a set of code (e.g., programs) and data that is stored in memory of one embodiment of a computing device, such as the computing device set forth in FIGS. 1 and 4. The computing device uses the code, in conjunction with a processor, to implement the necessary operations (e.g., logic operations) to implement the described herein.

Referring to FIG. 6, the memory 460 includes a capture module 601 which when executed by a processor is responsible for performing an image capture operation and creating digital content. The memory also stores a transmission module 602 which, when executed by a processor, is responsible for sending the digital content from the computing device. The memory also stores a display module 603 which, when executed by a processor, is responsible for displaying the code that the user can capture and decode to obtain their content from a data storage server, as well as display a message indicating the digital content has already been accessed. Memory 460 also stores a network communication module 604 used for performing network communication and communication with the other devices (e.g., servers, clients, etc.), to facilitate the transfer of the digital content and reception of the message indicating that the digital content is ready for access or has already been accessed.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
converting a paper document into digital content;
transferring the digital content via a network to a remotely accessible data storage server;
displaying a code on a display, the code encoding an address of the digital content in the network;
monitoring whether the digital content has been accessed;
receiving a request for the digital content from a second device, the request including the address created from data resulting from decoding the code; and
sending an HTML content stream to the second device, including an indication of a type of the digital content, in response to the request, the type information for use by a browser in determining an application or plug-in capable of rending the digital content on a display of the smart device.

2. The method defined in claim 1 wherein the code comprises a QR code.

3. The method defined in claim 1 wherein the code the code encodes a publically accessible internet address of the digital content.

4. The method defined in claim 1 wherein the code includes machine generated random characters.

5. The method defined in claim 1 wherein the network comprises the internet.

6. The method defined in claim 1 further comprising sending a message to the originating device for display to a user indicating the digital content was accessed.

7. The method defined in claim 6 further comprising deleting the digital content from the remotely accessible data storage server.

8. A method comprising:
acquiring a code displayed on a display of a first device using a camera of a second device, the code encoding an address of digital content stored in a remotely accessible data storage server coupled to a network after being converted from a paper document and transferred to the remotely accessible data storage server;
decoding data in the code;
creating the address from the data;
sending a request for the digital content through the network using the address created from the data;
receiving an HTML content stream from a remotely accessible data storage server, including an indication of the a type of the digital content, in response to the request;
retrieving the type from headers in the HTML content stream;
launching an application or plug-in capable of rendering the digital content; and
rendering the digital content on a display of the second device.

9. The method defined in claim 8 wherein the code comprises a QR code.

10. The method defined in claim 8 wherein the code the code encodes a publically accessible internet address of the digital content.

11. The method defined in claim 8 wherein the code includes machine generated random characters.

12. The method defined in claim 8 wherein the network comprises the internet.

13. The method defined in claim 8 further comprising:
a first device monitoring whether the digital content has been accessed;
determining the digital content was accessed; and
displaying a message indicating the digital content was transferred and is to be subsequently deleted from the remotely accessible data storage server.

14. An article of manufacture having one or more non-transitory computer readable media storing instructions thereon which, when executed by a system, cause the system to perform a method comprising:
converting a paper document into digital content;
transferring the digital content via a network to a remotely accessible data storage server;
displaying a code on a display, the code encoding an address of the digital content in the network;
monitoring whether the digital content has been accessed;
receiving a request for the digital content from a second device, the request including the address created from data resulting from decoding the code; and
sending an HTML content stream to the second device, including an indication of a type of the digital content, in response to the request, the type information for use by a browser in determining an application or plug-in capable of rending the digital content on a display of the smart device.

15. The article of manufacture defined in claim 14 wherein the code comprises a QR code.

16. The article of manufacture defined in claim 14 wherein the code the code encodes a publically accessible interne address of the digital content.

17. The article of manufacture defined in claim 14 wherein the code includes machine generated random characters.

18. The article of manufacture defined in claim 14 wherein the network comprises the interne.

19. The article of manufacture defined in claim 14 wherein the method further comprises sending a message to the originating device for display to a user indicating the digital content was accessed.

20. The article of manufacture defined in claim 19 wherein the method further comprises deleting the digital content from the remotely accessible data storage server.
